(19) United States
(12) Patent Application Publication
(10) Pub. No.: US 2026/0071951 A1
(43) Pub. Date: Mar. 12, 2026

(54) INTEGRATING CAVITY DEVICE FOR VOLUME INDEPENDENT MEASUREMENTS

(71) Applicant: MARAMA LABS LIMITED, Kelburn, Wellington (NZ)

(72) Inventors: Geoffry LAUFERSKY, Kelburn, Wellington (NZ); Matthias MEYER, Kelburn, Wellington (NZ); Brendan DARBY, Kelburn, Wellington (NZ)

(21) Appl. No.: 19/108,572

(22) PCT Filed: Sep. 6, 2023
(86) PCT No.: PCT/IB2023/058798

§ 371 Date: Mar. 4, 2025

(30) Foreign Application Priority Data
Sep. 7, 2022 (EP) 22194258.4

(51) Int. Cl. G01N 21/03; G01N 21/31

(52) U.S. Cl. CPC G01N 21/0303; G01N 21/31; G01N 2201/065

(57) ABSTRACT

The present invention concerns an Integrating cavity device for an optical cavity of an integrating cavity. The integrating cavity device comprises a container defining or comprising an inner receptacle or cavity configured to receive a liquid or a cuvette; and a masking enclosure configured to mask at least one portion of the inner receptacle or cavity. The integrating cavity device is configured to be received or held by an integrating cavity, and the integrating cavity device extends in an elongated manner so as to be located inside the optical cavity of the integrating cavity when received or held therein; and the masking enclosure extends along the container to mask, from optical cavity reflections, a first portion of the inner receptacle or cavity and a first portion of a liquid sample when received therein, or a first portion of a cuvette when received therein; and panoramically expose, to optical cavity reflections, a second portion of the inner receptacle or cavity or a second portion of the cuvette when received in the inner receptacle or cavity.

### FIELD OF THE INVENTION

The present invention concerns an integrating cavity device for an optical cavity of a spectrometer integrating cavity, and also concerns a spectrometer integrating cavity comprising an integrating cavity device.

### BACKGROUND

Countless industries and fields of study rely on illuminating a sample with ultraviolet, visible, or infrared energy to analyze how the materials in the sample interact with the light source. In highly controlled studies, this can reveal a wealth of analytical information such as the color, chemical composition, relative and specific concentrations of individual components, and how each of these changes with the introduction of experimental variables. As this kind of information is widely applicable to many research, development, and production endeavors, there is always a large interest in improving the accuracy of these measurements and reducing the effort it takes to acquire them.

By comparing the light interactions of a sample of interest to those of a reference sample, a relationship between them can be established that indicates how much more the sample materials absorb light. As such, this process is typically called absorption and the strength of the response relies upon a relationship between the concentration of the materials in the sample and the distance, or path length, the light travels as it passes through the sample. Because the concentration is usually the variable being investigated, there are a number of modern solutions available to control the path length of the measurement, most of which involve precisely controlling the optical arrangement of the sample vessel, light source, and detection device.

For liquids, the most common vessels are called cuvettes, and are generally precisely-machined squared ‘tubes’ of optically transparent glass or quartz with an open top and closed bottom. These vessels are then held in a specific position through engineering applications such as spring steel clamps to achieve an optimum optical arrangement. FIG. 1 shows exemplary known cuvettes with 10 mm, 2 mm, and 1 mm internal cavity widths (left to right).

One common method of measuring the absorption of a sample is to measure the light as it passes from one side of a cuvette through the other, which can be considered a transmission-based setup. Because of the precision of cuvette manufacture, samples in these kinds of arrangements have highly reliable path lengths, which means the produced absorption information is specific for concentration. Because the light is traveling in a well-described path at a fixed height in the cuvette, measurements in these systems do not typically depend much on the volume of sample placed inside the cuvette beyond some minimum working height. FIG. 2 shows an example of such a known and typical transmission-based spectroscopic arrangement with a graph schematically representing a detector response with changing sample volume. The lowest detectable and minimum working heights (or volumes) for this setup are labeled H_{low} and Hₘᵢₙ, respectively.

One drawback of these systems and setups is that the light must pass completely through the sample, so they cannot be used if the sample is cloudy, solid, or otherwise unable to travel from one side of the cuvette to the other.

A way to acquire the same information for such systems and address this drawback is to collect all of the light that reflects or is otherwise redirected off the sample and compare that behavior against a reference. These methods typically rely on placing the cuvette into an integrating cavity, which randomly reflects light off of its surface. This serves both to uniformly illuminate the sample from all directions and to pass the collected light to the detection device. FIG. 3 shows an example of a known and typical integrating cavity-based spectroscopic arrangement where light is redirected around the optical cavity of the integrating cavity and passes through or reflects off the sample. FIG. 3 also shows a graph schematically representing detector response with changing sample volume with this setup or system.

Because the collected and detected light includes that which was scattered off the sample, any losses seen when compared to a reference are now purely due to absorption processes. In addition, as the light bounces around inside the cavity, it can cross through the cuvette multiple times, which can result in the detection of far smaller amounts of sample.

However, because the paths of the light can now intersect at any angle along the whole cuvette, these measurements are very responsive to small differences in volumes of the sample, as can be understood from the graph schematically representing detector response in FIG. 3.

Integrating cavity-based optical experiments or systems thus have technically challenging hurdles to their use, which has hampered their uptake by fields that would benefit from them.

Benefits of these measurements are obtained because everything placed inside an integrating cavity is examined from all angles, which results in very sensitive results. However, to get useful comparisons, one must produce highly precise and repeatable volumes of samples for analysis, which is often an overburdensome challenge.

So despite their advantages with cloudy or low-concentration samples, complications such as these make integrating cavity or integrating sphere measurements much more technically challenging than transmission-based methods and regularly inhibit their wider application to fields that could benefit from their use.

### SUMMARY OF INVENTION

The present invention addresses the above-mentioned drawbacks. According to one aspect of the present invention, an integrating cavity device for an optical cavity of an integrating cavity is provided, the integrating cavity device comprising a container defining or comprising an inner receptacle or cavity configured to receive a liquid or a cuvette, and a masking enclosure configured to mask at least one portion of the inner receptacle or cavity. The integrating cavity device is configured to be received or held by an integrating cavity, and the integrating cavity device extends in an elongated manner so as to be located inside the optical cavity of the integrating cavity when received or held therein. The masking enclosure extends along the container to mask, from optical cavity reflections, a first portion of the inner receptacle or cavity and a first portion of a liquid sample when received therein, or a first portion of a cuvette when received therein; and panoramically expose, to optical cavity reflections, a second portion of the inner receptacle or cavity or a second portion of the cuvette when received in the inner receptacle or cavity.

The masking enclosure can extend along the container to define at least one concealed inner receptacle section and to permit panoramic exposure of the second portion of the inner receptacle or cavity to optical cavity reflections, or permit panoramic exposure of the second portion of the cuvette to optical cavity reflections when received in the integrating cavity device.

The masking enclosure can extend along the container to delimit at least one unconcealed inner receptacle section that panoramically exposes a standardized fluidic volume Vₘᵢₙ to optical cavity reflections, or to permit to delimit at least one unconcealed inner receptacle section of the cuvette to panoramically expose a standardized fluidic volume Vₘᵢₙ to optical cavity reflections.

The container may include at least one elongated hollow passage extending fully through the container.

The integrating cavity device can further include positioning means configured to locate a standardized fluidic volume Vₘᵢₙ of the cuvette outside the container for exposure to optical cavity reflections of the integrating cavity.

The positioning means may comprise a wedging or blocking mechanism configured to wedge or block the cuvette against the integrating cavity device, or at least one detent mechanism, or at least one set screw, or at least one mount extending from the container and defining a landing configured to position a base of the cuvette at a standardized distance Hₘᵢₙ from the container. The container 23 may include at least one elongated hollow passage extending through the container and a base sealing the elongated hollow passage to define the inner receptacle for receiving and holding the liquid.

The container may include at least one unconcealed inner receptacle section defining a standardized fluidic volume Vₘᵢₙ for panoramic exposure to optical cavity reflections.

The container may include at least one outer surface and at least one inner surface, and the masking enclosure may extend on the at least one outer surface or on the at least one inner surface.

The masking enclosure may comprise a deposit deposited and adhered to the at least one outer surface or to the at least one inner surface of the container.

The masking enclosure may comprise a diffusely or specular reflecting material, or a broadband light absorbing material.

The masking enclosure may comprise a diffusely or specular reflecting material extending on the at least one outer surface, and an absorbing material extending on the at least one inner wall to provide a double light shield of the at least one portion of the inner receptacle or cavity.

The integrating cavity device may include an upper integrating cavity engagement connection or connector configured to connect or attach the integrating cavity device to a sample port of the integrating cavity to allow an upward and downward displacement of the liquid and the cuvette inside the integrating cavity when the liquid and the cuvette are inserted into the integrating cavity.

The upper integrating cavity engagement connection or connector can be configured to connect or attach the integrating cavity device to the integrating cavity at a summit of the integrating cavity to hold the integrating cavity device suspended and extending inside the integrating cavity from the connection of the integrating cavity device at the summit of the integrating cavity.

A further aspect of the present invention concerns an integrating cavity including the integrating cavity device.

At least one port of the integrating cavity may include the integrating cavity device that extends from an opening or channel defined by the port and extends inside the optical cavity of the integrating cavity.

The integrating cavity device may be of unitary construction with the integrating cavity and extend inside the optical cavity of the integrating cavity.

A first port of the integrating cavity may include a first integrating cavity device, and a second port of the integrating cavity may include a second integrating cavity device, the first and second ports being located opposite each other to allow a cuvette to extend between the first and second ports.

Yet a further aspect of the present invention concerns a spectroscopic measurement method. The method may include providing the integrating cavity device, or the integrating cavity and using the provided integrating cavity device or the provided integrating cavity to obtain spectroscopic measurements.

The integrating cavity device of the present disclosure substantially lowers the previously mentioned barriers and inconveniences inhibiting wider application by intentionally masking at least a portion of the sample vessel from exposure or view. The characteristics of the integrating cavity device and the properties of the device surfaces advantageously preserve the optical integrity of the system and the quality of the resulting data. The combination of device features, geometry and material advantageously allows for a significant reduction in sample preparation time as well as an increase in measurement accuracy.

Moreover, the specifics to the device design are agnostic, which allows it to be easily adapted as an add-on to existing measurement systems, or to be featured explicitly in bespoke systems.

The device and systems of the present disclosure advantageously make spectroscopic measurements insensitive to sample volume. In particular, device and systems of the present disclosure allow any volume beyond the designed minimum to be placed inside the cuvette with no meaningful changes in the resulting spectral data, produces minimal changes to the total amount of light that survives in the system, and is agnostic for experimental setup such as cuvette design, optical arrangement, and materials sampled.

The integrating cavity device advantageously renders the volume of sample inside a cuvette to be unmeasurable beyond a designed threshold volume or cuvette height.

The use of a reflective material on the exterior of the integrating cavity device advantageously preserves a significant amount of the light in the system, producing minimal changes in measurement range of the system it is used in.

The use of an internal absorbing layer in the integrating cavity device will further improve the device accuracy, although it is not necessary to obtain the previously mentioned advantages.

The integrating cavity device is advantageously not dependent on experimental particulars, and brings significant improvements to experimental setups or systems that incorporates it intentionally. The integrating cavity device may be a removable device which is advantageous for adapting this technology to existing systems. Alternatively, the integrating cavity device may be a permanent device of the experimental setup or system allowing to improve consistency and accuracy in bespoke systems.

The above and other objects, features, and advantages of the present invention and the manner of realizing them will become more apparent, and the invention itself will best be understood from a study of the following description with reference to the attached drawings showing some preferred embodiments of the invention.

### A BRIEF DESCRIPTION OF THE SEVERAL VIEWS OF THE DRAWINGS

FIG. 1 shows, from left to right, exemplary known cuvettes with 10 mm, 2 mm, and 1 mm internal cavity widths (left to right).

FIG. 2 shows an example of a known and typical transmission-based spectroscopic arrangement (left) with a graph schematically representing detector response with changing sample volume (right). The lowest detectable and minimum working heights (or volumes) for this setup are labeled H_{low} and Hₘᵢₙ, respectively.

FIG. 3 shows an example of a known and typical integrating cavity-based spectroscopic arrangement (left) where light is able to bounce around the cavity and pass through or reflect off the sample. Included is a graph schematically representing detector response with changing sample volume with this setup (right).

FIG. 4A schematically shows an exemplary embodiment of an integrating cavity device (center) according to the present disclosure, along with an exemplary cuvette (for example, a 10 mm cuvette) configured to be received by the integrating cavity device. The assembled integrating cavity device and cuvette are also shown (right).

FIGS. 4B and 4C are exemplary cross-sectional representations of the integrating cavity device of FIG. 4A taken along A-A′. FIG. 4D shows another exemplary embodiment of the integrating cavity device according to the present disclosure. FIG. 4E shows an exemplary holding device for the integrating cavity device according to the present disclosure.

FIG. 5A schematically shows another exemplary embodiment of an integrating cavity device according to the present disclosure. FIGS. 5B and 5C are exemplary cross-sectional representations of the integrating cavity device of FIG. 5A. FIG. 5D is a schematic of the integrating cavity device of FIG. 5A held and positioned in an integrating cavity.

FIG. 6 shows an exemplary use of the integrating cavity device (left) of the present disclosure where the integrating cavity device is, for example, the device shown in FIG. 4A. The total light available to the system is preserved, and the integrating cavity device assures that the volume inside the cuvette beyond the minimum working height, Hₘᵢₙ, is not accessible. Included is the resulting schematic graph of detector response to changes in sample volume obtained with this setup (right) that uses the integrating cavity device of the present disclosure.

FIGS. 7A and 7B show different examples of the assembly of an ‘overfilled’ cuvette with the integrating cavity device of FIG. 4A, which can be assembled for example to a cuvette in a sliding manner as a sleeve (left), and be configured as a cuvette holder or cuvette mount with shield walls (right).

FIGS. 8A and 8B show further exemplary embodiments of integrating cavity devices of the present disclosure included in an integrating cavity and, for example, concern what can be considered static improvements to the integrating cavity to mitigate the negative effects of volume differences via modification of the integrating cavity sample port (FIG. 8A), or including for example an anchored sample mount attached to integrating cavity device of FIG. 4A (FIG. 8B). The cuvette is depicted before insertion (left) and after insertion (right) in FIGS. 8A and 8B. FIG. 8C shows yet a further exemplary embodiment in which a plurality of integrating cavity devices of the present disclosure are included in an integrating cavity 7.

FIG. 9 shows an example of a further alternative embodiment of the integrating cavity device in which absorption-based blocking/masking is employed in an integrating cavity device to interact with light in an integrating cavity (left), and also shown (right) is a comparison of the detector responses of this system against that of the reflective-based blocking/masking approach of FIG. 6 with increasing concentrations of sample (right).

FIG. 10A shows the integrating cavity device of the present disclosure, and FIG. 10B shows an example of a further embodiment of the integrating cavity device. FIG. 10A shows an example of how light may interacts with the internal surface of integrating cavity device if masking were assured using only reflecting materials and FIG. 10B shows integrating cavity device additionally including an internal absorbing surface or material.

FIG. 11 shows a further exemplary embodiment of an integrating cavity device of the present disclosure included in an integrating cavity and, for example, concern what can be considered a static improvement to the integrating cavity to mitigate the negative effects of volume differences via modification of the integrating cavity sample port.

Herein, identical reference numerals are used, where possible, to designate identical elements that are common to the Figures.

### DETAILED DESCRIPTION OF SEVERAL EMBODIMENTS

FIGS. 4A to 4C, 5A to 5D, 6, 7A to 7B, 8A to 8C, 9, 10A to 10B, and 11 show exemplary devices 1 or integrating cavity devices 1 according to the present disclosure.

The device 1 or integrating cavity device 1 is, for example, for an optical cavity 5 of an integrating cavity or integrating sphere 7.

The integrating cavity or integrating sphere 7 is configured to receive light through a first port to introduce light into the optical cavity 5 of the integrating cavity 7 where the light undergoes multiple reflections distributing the light inside the optical cavity 5 with the light exiting the integrating cavity 7 via a second port.

The integrating cavity or sphere 7 may, for example, be included in a spectrometer system comprising, for example, at least one light source arranged to provide light into the integrating cavity 7, and an optical detector and/or spectrometer arranged to receive light exiting the integrating cavity 7 after having interacted with a reference or measurement sample positioned inside the integrating cavity 7. The spectrometer system may of course additionally include other components.

An exemplary and non-limiting spectrometer apparatus, in which the integrating cavity device 1 or integrating cavity 7 of the present disclosure may be used, is described in international patent application WO2018070882, the entire contents of which are fully incorporated herein by reference.

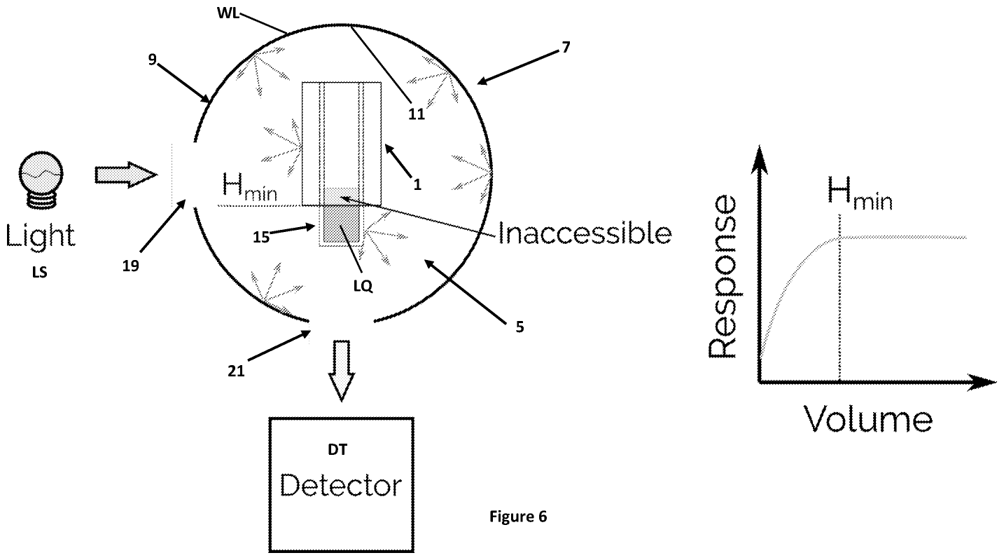

The integrating cavity 7 (see, for example, FIG. 6) may include a hollow body 9 comprising at least one or a plurality of walls WL comprising a reflective inner surface 11. The integrating cavity 7 is configured to retain or support the integrating cavity device 1 and/or a cuvette 15 so that the integrating cavity device 1 and/or a cuvette 15 extend inside the optical cavity 5, for example, towards the center of the optical cavity 5.

The integrating cavity device 1 may, for example, be integrally formed with the integrating cavity 7, for example, integrally formed as part of the hollow body 9 to be permanently part of the integrating cavity 7, as is described in further detail below. Alternatively, the integrating cavity device 1 is removable from the integrating cavity 7.

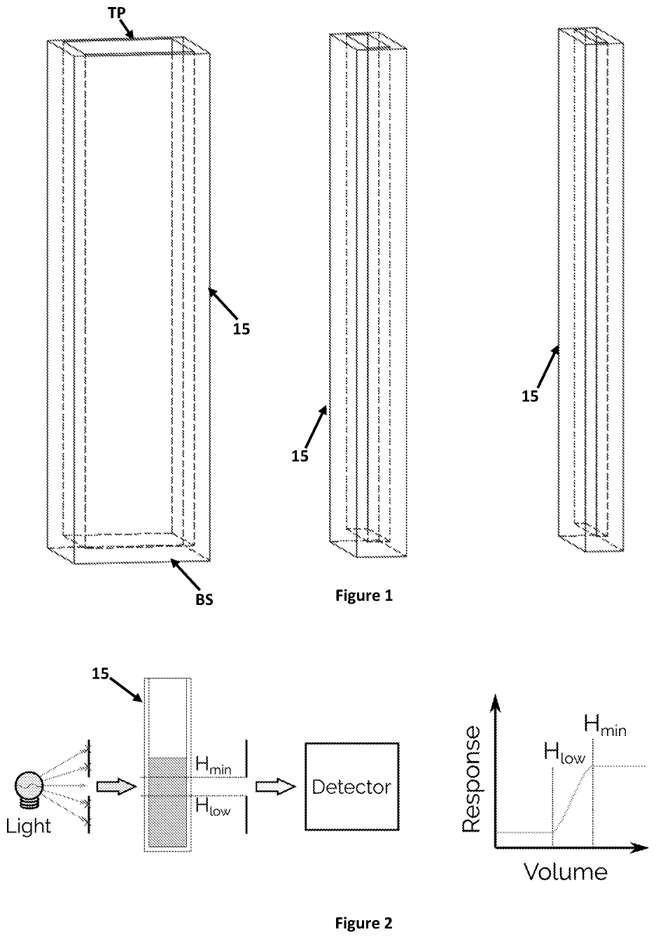

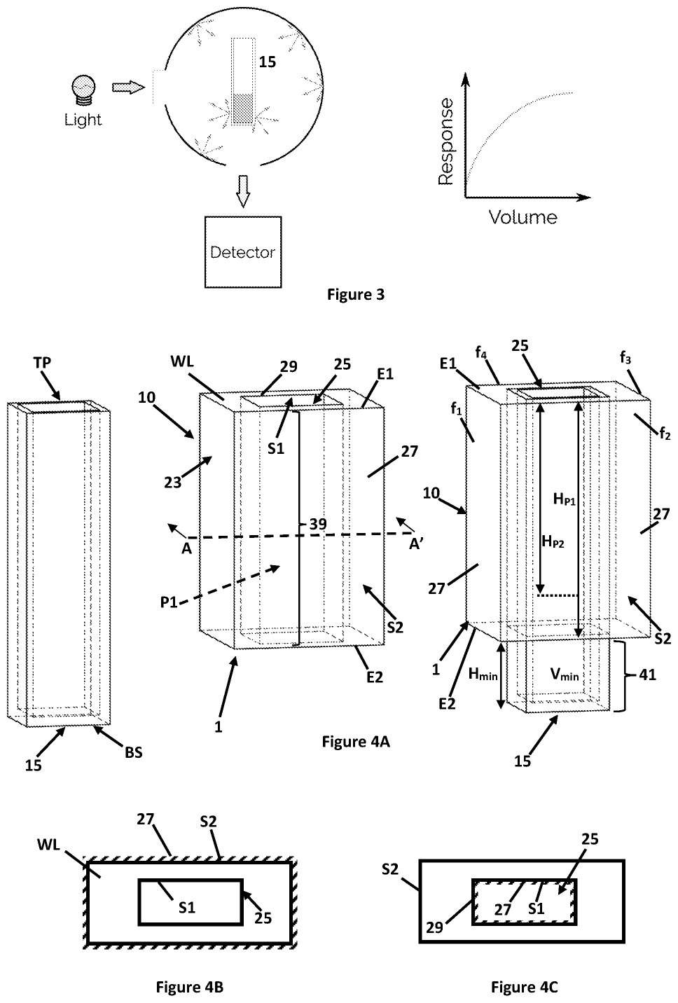

The cuvette 15 may, for example, be a known cuvette that is a vessel or container configured to hold a liquid LQ that is to undergo optical or spectroscopic investigation, such as that shown in FIG. 1. The cuvette 15 can thus be, for example, a cross-sectionally square or rectangular tube of optically transparent material (for example, glass or quartz) at the wavelengths of interest, and includes an open end or open top TP and a base BS comprising a closure or closed bottom to retain a liquid inside.

The hollow body 9 and/or the reflective inner surface 11 defines the optical cavity 5 of the integrating cavity device 1 in which light is received therein through at least one light inlet port 19, and is reflected multiple times before exiting the optical cavity 5 and the integrating cavity 7 via an outlet port 21.

The integrating cavity device 1 permits a liquid sample to be investigated to be located inside the optical cavity 5, for example, at a center of the optical cavity, and to undergo multiple interactions with light reflected multiple times inside the optical cavity 5.

The integrating cavity 7 thus comprises at least one or multiple light inlet ports 19 and at least one light outlet port 21. The inlet port 19 and the outlet port 21 define openings permitting light to enter and exit the optical cavity 5. The inlet port 19 may, for example, be arranged with respect to the light source LS to receive light therefrom and the light outlet port 21 may be arrange with respect to the detector and/or spectrometer so that light exiting the light outlet port 21 is directed or propagates to the detector and/or spectrometer DT. This permits spectroscopy or optical measurements to be performed on a liquid sample located in the integrating cavity 7.

The reflective inner surface 11 may be diffusely or specular reflecting. The wall of the integrating cavity 7, for example, includes a coating to provide a specular and/or diffuse reflectance in wavelength ranges such as the UV, visible, or infrared regions, or combinations thereof.

The hollow body 9 and/or the integrating cavity 7 may, for example, have a spherical geometry to define a spherical optical cavity 5. However, other non-spherical geometries are also possible such as cylindrical or cuboidal.

FIG. 4A shows one exemplary embodiment of the integrating cavity device 1, 10 according to the present disclosure. The integrating cavity device 10 comprises a container 23 defining or comprising an inner receptacle or inner cavity 25 configured to receive the cuvette 15. The inner receptacle 25 extends fully through the container 23 and includes opposing openings allowing the cuvette 15 to pass therethrough.

The integrating cavity device 10 further includes a masking enclosure (or concealing encasement) 27 configured to optically mask or conceal at least a portion P1 of the inner receptacle (or cavity) 25 from incident or impinging light, for example, reflected from the inner surface 11 of the optical cavity 5.

The masking enclosure 27 encloses or surrounds the inner receptacle 25 to shield the inner receptable 25 from incident or impinging light.

The container 23 includes a hollow passage 29, for example, an elongated hollow passage 29 extending fully through the container 23. The container 23 comprises a first or upper opening at a first or upper extremity E1 and a second or lower opening at a second or lower extremity E2. The first or upper opening is configured to receive the closed end or base BS of the cuvette 15 during insertion of the cuvette 15. The second or lower opening at the extremity E2 allows the closed end of the cuvette 15 to exit the container 23 at the second or lower extremity E2.

The container 23 thus includes a bore running fully through the container 23 from the upper extremity E1 to the lower extremity E2 allowing the closed end of the cuvette 15 to be inserted at the upper extremity E1 and be displaced entirely through the integrating cavity device 10 and to exit at the lower extremity to locate or fix a predetermined or standardized fluidic volume Vₘᵢₙ Or a predetermined or standardized cuvette section of length/height Hₘᵢₙ outside of the container 23 and the integrating cavity device 10, as shown in FIG. 4A (right).

The integrating cavity device 10 may include, for example, positioning means or a positioning mechanism (not shown) or a positioner configured to locate or fix the standardized fluidic volume Vₘᵢₙ or a predetermined or standardized cuvette section of length/height Hₘᵢₙ of the cuvette 15 outside the container 23 (each time the cuvette 15 is inserted) for exposure to optical cavity reflections.

The positioning means or mechanism may, for example, be housed or located in a surrounding wall or body WL of the device 10, or for example, may be located at the first or upper extremity E1 to act on the cuvette 15 at the first or upper extremity E1.

The positioning means or mechanism may, for example, comprise a wedging or blocking mechanism configured to wedge or block the cuvette 15, for example, against the integrating cavity device 10 or against an inner surface S1 of the integrating cavity device 10 to fix the cuvette 15 in a position relative to the integrating cavity device 10 and locate or fix the standardized fluidic volume Vₘᵢₙ or the predetermined or standardized cuvette section of length/height Hₘᵢₙ of the cuvette 15 outside the container 23.

The positioning means or mechanism may, for example, comprise at least one set screw for example a grub screw or blind screw, for example, housed or located in a surrounding wall or body WL of the container 23 or device 10, and that can be rotated and displaced in a first direction to contact the cuvette 15 to temporarily block or hold the cuvette 15 against the integrating cavity device 10 when located inside the device 10. Displacement in a second direction opposite to that of the first direction permits unblocking and removal of the cuvette 15.

The positioning means or mechanism may alternatively or additionally, for example, comprise at least one detent mechanism (for example, a ball-detent) housed or located in the surrounding wall or body WL of the container 23 or device 10, and that contacts the cuvette 15 when the cuvette 15 is placed inside the container 23 in the passage 29 to temporarily block or hold the cuvette 15 against the detent and/or the integrating cavity device 10. The detent mechanism permits a rapid insertion and removal of the cuvette 15.

The positioning means may, for example, alternatively or additionally comprise one or more spring clamps located in the inner receptacle 25, for example, on the inner surface S1 of the container 23 or in the inner receptable 25.

The positioning means or mechanism may, for example, alternatively or additionally comprise an interference fit or pressed fit between the container 23 and the cuvette 15.

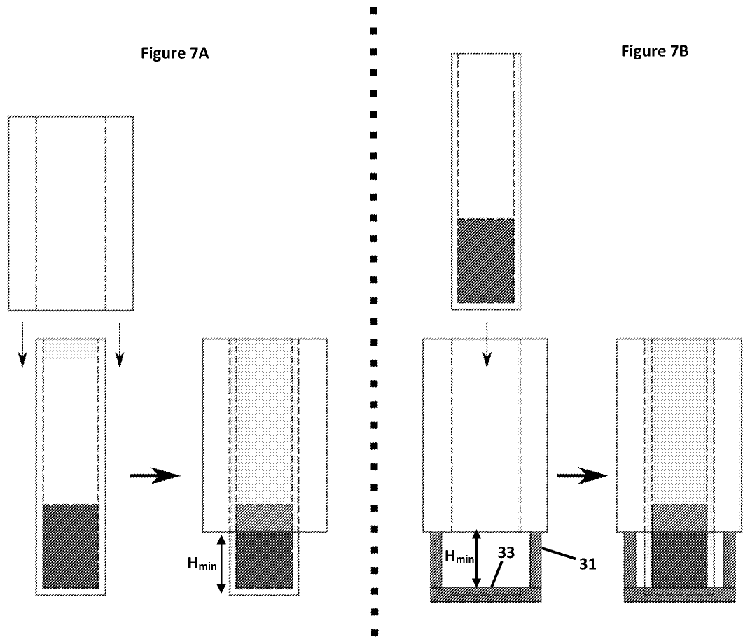

The positioning means may, for example, alternatively comprise at least one mount 31 (FIG. 7B) extending from the second or lower extremity E2 of the container 23 and defining a landing 33 configured to receive the base BS of the cuvette 15 and to position the base BS of the cuvette 15 at a standardized distance Hₘᵢₙ from the container 23 each time the cuvette 15 is inserted. The mount 31 thus locates or fixes a predetermined or standardized fluidic volume Vₘᵢₙ or a predetermined or standardized cuvette section of length/height Hₘᵢₙ outside of the container 23 for light interaction.

A predetermined or standardized volume Vₘᵢₙ or a predetermined or standardized cuvette section of length/height Hₘᵢₙ can thus repeatedly be located outside of the integrating cavity device 10 and permits to restrict light exposure of a liquid in the cuvette 15 to the same predetermined or standardized volume Vₘᵢₙ each time the cuvette 15 is assembled in the integrating cavity device 10.

As shown in FIGS. 7A and 7B, the cuvette 15 can be slidably received inside the integrating cavity device 10 which forms a sleeve structure or sleeve device surrounding the cuvette 15.

FIGS. 7A and 7B show different examples of the assembly of an ‘overfilled’ cuvette with the integrating cavity device 10 of FIG. 4A, which can be assembled for example to a cuvette in a sliding manner as a sleeve (left), and be configured as a cuvette holder or cuvette mount with shield walls (right) when mount 31 is included.

The container 23 includes the at least one wall or body WL, for example, an elongated and surrounding wall WL (FIG. 4A) defining the inner receptacle 25 and/or the hollow passage 29. The at least one wall WL comprises or defines an inner surrounding surface S1 of the container 23. The inner surrounding surface S1 surrounds or encircles the cuvette 15 when located inside the container 23.

The container 23 further includes an outer surrounding surface S2. The at least one wall WL may, for example, define the outer surface S2. The outer surrounding surface S2 surrounds or encircles the inner surrounding surface S1 and the inner receptacle 25.

The masking enclosure 27 may be provided/deposited on or attached to the outer surface S2 of the container 23, as shown in FIG. 4B. The masking enclosure 27 may, for example, be or comprise a deposit or deposit layer (or bound deposit or bound deposit layer) deposited on and/or adhered/stuck to the outer surface S2 of the container 23. Alternatively or additionally, the material of the outer surface S2 of the container 23 may define the masking enclosure 27. The outer surface S2 may, for example, be patterned or have a non-transmitting roughness or a diffusive surface roughness.

The masking enclosure 27 may, for example, comprises or consists of a diffusely or specular reflecting material or layer; or a broadband light absorbing material or layer.

The diffusely reflecting material or layer may, for example, comprise or consist of diffusely reflecting components such as barium sulfate, magnesium oxide, or a plastic (for example, Polytetrafluoroethylene (PTFE)). The specular reflecting material or layer may, for example, comprise or consist of aluminum, silver or steel.

While a reflecting material is preferred for the masking enclosure 27 and for the exterior of the integrating cavity device, broadly-absorbing materials such as black paints, anodized metals, or smoky glasses may be alternatively be used to achieve similar effects.

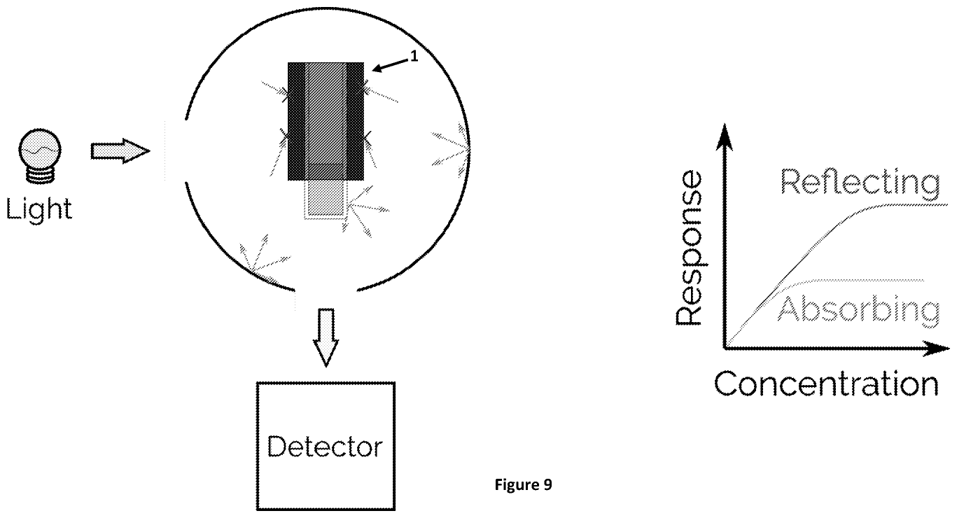

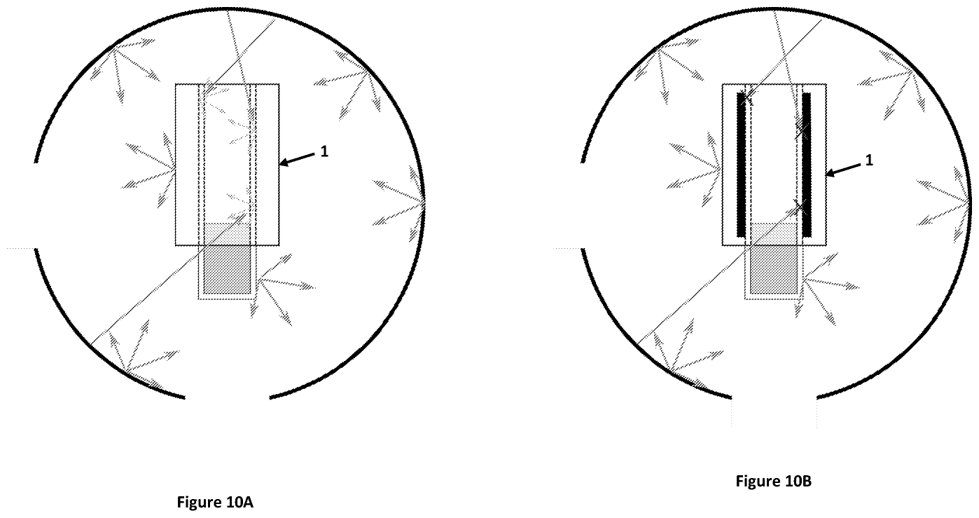

FIG. 9 shows this further alternative embodiment of the integrating cavity device in which absorption-based blocking/masking is employed for the masking enclosure 27 and in an integrating cavity device to interact with light in an integrating cavity (left), and also shown (right) is a comparison of the detector responses of this system against that of the reflective-based blocking/masking approach of FIG. 6 with increasing concentrations of sample (right). Any light that interacts with such an absorbing blocking device is quenched, so any sample found on the inside of the device would also be undetectable. However, because so much of the light inside of an integrating cavity 5 is able to interact with the exterior of the integrating cavity device, there is a significant reduction in the total amount of light available to the system.

Alternatively or additionally, the masking enclosure 27 may be provided/deposited on or attached to the inner surface S1 of the container 23 (for example, in the same manner previously described in relation to outer surface S2) to optically mask or conceal at least a portion P1 of the inner receptacle 25 from incident or impinging light, as shown in FIG. 4C.

The masking enclosure 27 comprises or consists of a material that shields, masks or conceals one or more portions P1 of the inner receptacle 25 or the content of the inner receptacle 25. A portion of the cuvette 15 is thus shielded from incident or impinging light when received in the inner receptacle 25.

The masked portion P1 of the inner receptacle 25 may, for example, be a circumferential or tubular masked portion, as shown cross-sectionally in FIGS. 4B and 4C. The circumferential portion may extend fully or partially circumferentially and extends in an elongated direction extending in a direction of displacement of the cuvette 15 inside the container 23 or integrating cavity device 10.

The masking enclosure 27 may, for example, extend to cover (substantially) the entire circumferential outer surface S2 of the container 23 that encircles the inner receptacle 25, for example, circumferential outer surface S2 made up of façade surfaces f₁, f₂, f₃ and f₄ as shown in the specific exemplary rectangular cross-sectional shape of the exemplary container 23 of FIG. 4A (right), where facades f₁ and f₃ are located opposite each other, as are facades f₂ and f4.

As a result, an elongated circumferential portion of the inner receptable 25 and/or the cuvette 15 is circumferential shielded from laterally incident or impinging light, that is, a surround shielding of the inner receptable 25 is obtained.

According to another embodiment, the masking enclosure 27 extends or covers the outer surface S2 to assure circumferential shielding as described above but extends to provide a partial elongated circumferential shielding. The masking enclosure 27 extends, on the outer surface S2, a distance H_{P2} (FIG. 4A (right)) from the upper extremity E1 that is less than the total distance H_{P1} between the upper extremity E1 and the lower extremity E2, for example between 5% and 35% less than the total distance H_{P1}. This permits to set different values for Vₘᵢₙ or Hₘᵢₙ using the same standard container 23.

A first portion (for example, an elongated circumferential portion) of the inner receptacle 25 and/or the cuvette 15 is thus shielded from incident or impinging light or optical reflections of the optical cavity 5, while a second or lower portion of the inner receptacle 25 and/or the cuvette 15, that is to be located closer to the center of the integrating cavity 7, is panoramically or fully panoramically exposed to incident or impinging light or optical reflections of the optical cavity 5.

The liquid or fluidic volume exposed to incident or impinging light or optical reflections of the optical cavity 5 is largely restricted to the standardized or preset liquid or fluidic volume Vₘᵢₙ located in the second or lower portion of the cuvette 15.

The masking enclosure 27 may thus extend along the container 23 to mask a first or upper portion of the inner receptacle 25, and/or a first portion of the cuvette 15 and panoramically expose, to incident or impinging light or optical reflections of the optical cavity 5, a second or lower portion of the inner receptacle 25 or a second or lower portion of the cuvette 15 when received in the inner receptacle 25.

Alternatively, or additionally, the masking enclosure 27 may similarly extend to partially or fully cover the inner surface S1 of the container 23 to shield an elongated circumferential portion of the inner receptable 25 and/or the cuvette 15. The masking enclosure 27 may, for example, be present on both the inner surface S1 and the outer surface S2, fully or partially in a manner assuring shielding of the inner receptacle 25 and/or the cuvette 15.

The masking enclosure 27 defines a concealed inner receptacle section 39 and permits (partial or full) panoramic exposure of a second or lower portion 41 of the cuvette 15 to optical cavity reflections when received in the inner receptacle 25.

The masking enclosure 27 extends along the container 23 permitting to delimit an unconcealed inner receptacle section of height Hₘᵢₙ Of the cuvette 15 and permitting to panoramically expose the preset or standardized fluidic volume Vₘᵢₙ to incident light or optical cavity reflections.

The inner receptacle 25 (and/or or hollow passage 29) may, for example, define or have the same or a complementary cross-sectional shape to that of the cuvette 15 permitting the cuvette 15 to be easily received and guided inside the integrating cavity device 10. FIG. 4A shows an exemplary and non-limiting rectangular cross-section but other cross-sectional shapes are possible such as circular, square, or triangular.

The integrating cavity device 10 is configured to be received or held by the integrating cavity 7. The integrating cavity device 10 may, for example, be held by or attached to the integrating cavity 7 at a summit (or apex or zenith) of the integrating cavity 7.

The integrating cavity device 10 may, for example, be held or attached to the integrating cavity 7 by a form-fit or a press-fit or an interference fit. The integrating cavity device 10 may include, for example, a summit or upper integrating cavity engagement connection or connector 37 configured to connect or attach to the integrating cavity (7). The summit or upper integrating cavity engagement connection or connector 37 may, for example, be located at the first or upper extremity E1 of the integrating cavity device 10, and/or at an extremity opposite the second or lower opening at a second or lower extremity E2 of the integrating cavity device 10.

The integrating cavity 7 may include, for example, at least one or an outer depression or recess 35 configured to engage with one or more (at least one) engaging protrusions or winglets 37 of the integrating cavity device 10 (or vice versa), as for example shown in FIG. 4D.

The protrusions or winglets 37 may, for example, have a thickness permitting the integrating cavity device 10 to protrude from the integrating cavity 7 allowing easier removal.

The summit or upper integrating cavity engagement connection or connector 37 may, for example, be configured to connect or attach the integrating cavity device 10 to (or at) a sample port SP of the integrating cavity (7). The sample port SP may include, for example, the at least one outer depression or recess 35, as shown in the exemplary embodiment of FIG. 4D.

The summit or upper integrating cavity engagement connection or connector 37 is, for example, configured to connect or attach the integrating cavity device 10 to the integrating cavity 7 at, for example, a summit (or apex or zenith) of the integrating cavity 7. This holds the integrating cavity device 10 suspended and/or extending inside the integrating cavity 7 from the connection of the integrating cavity device 10 at the summit of the integrating cavity 7.

The sample port SP may, for example, be located at the summit (or apex or zenith) of the integrating cavity 7.

The integrating cavity device 10 extends, for example, in an upright or erect manner on or inside the integrating device 7. The integrating cavity device 10 extends, for example, from the summit connection downwards towards the center of the optical cavity 5 or integrating cavity 7.

The summit or upper integrating cavity engagement connection or connector 37 is, for example, configured to connect or attach the integrating cavity device 10 to the integrating cavity 7 to allow an upward and/or downward displacement of the liquid (to be investigated or to undergo measurement or having undergone measurement) and/or the cuvette 15 inside the integrating cavity 7, for example, when the liquid and/or the cuvette 15 is received or inserted into the integrating cavity 7. The summit or upper integrating cavity engagement connection or connector 37 is, for example, configured to connect or attach the integrating cavity device 10 to the integrating cavity 7 to allow a non-lateral displacement of the liquid and/or the cuvette 15 inside the integrating cavity 7, for example, when the liquid and/or the cuvette 15 is received or inserted into the integrating cavity 7. The downward direction is, for example, in a direction of a supporting surface upon which the integrating cavity 7 and/or the integrating cavity device 10 is held or supported, and the upward direction being a direction opposite to the downward direction.

This summit or upper integrating cavity engagement connection or connector 37 allows for easier handling and manipulation of liquid samples into and out of the integrating cavity 7. A (substantially) vertical/upright movement or displacement upward and/or downward of the liquid avoids generating lateral forces that may result in a liquid spill, for example, onto or inside the integrating cavity 7.

The integrating cavity device 10 extends, for example, into the integrating cavity 7 towards the center of the optical cavity 5 so that the cuvette 15, when received inside the integrating cavity device 10, has its base BS and/or second portion 41 located centrally inside the integrating cavity 7 and at a measurement position.

The integrating cavity device 10 may for example, in one exemplary embodiment, consist solely of or be made of a non-magnetic material or materials, or a non-ferromagnetic material or materials.

The integrating cavity device 10 may, for example, be configured to hold a cuvette 15 to allow light to pass or transmit fully through a first and second side or wall of the cuvette 15 (and, when present, a liquid located therebetween), the first side or wall being located directly opposite or directly facing the second side or wall.

Alternatively, a mount or holder device configured to receive/grip the base BS of the cuvette 15 may be included, and the mount may be permanently fixed inside the integrating cavity 7, or alternatively is inserted into the integrating cavity 7 with the integrating cavity device 10 and cuvette 15 to locate the integrating cavity device 10 and cuvette 15 inside the integrating cavity 7. The mount can, for example, be inserted into the integrating cavity 7 and be removably seated in a lower section of the integrating cavity 7 while holding the device 10 and cuvette in a measurement position, or can be seated on a surface external the integrating cavity 7 and extend from that external surface into the integrating cavity 7 to locate the integrating cavity device 10 and cuvette 15 inside the integrating cavity 7 in a measurement position.

Alternatively, a mount or holder device 51 (FIG. 4E) configured to receive and hold the integrating cavity device 10 is included and configured to be received by a receiving surface 53 of the integrating cavity 7 located around the sample port SP. The mount or holder device 51 is configure to hold the integrating cavity device 10 to locate the integrating cavity device 10 in an aligned position and extending into the integrating cavity 7 so that the cuvette 15 can be received inside the integrating cavity device 10 (for example, inserted through an upper sample port SP) with the base BS of the cuvette 15 being located centrally inside the integrating cavity 7 and at a measurement position. The mount or holder device 51 may be configured to adjust the position of the base BS of the cuvette 15 inside the integrating cavity 7, for example, to raise or lower the location of base BS of the cuvette 15.

The integrating cavity device 10 extends in an elongated manner so as to be located inside the optical cavity 5 of the integrating cavity 7 when received or held by the integrating cavity 7.

FIG. 6 shows an exemplary use of the integrating cavity device 10 (left) of the present disclosure where the integrating cavity device 1 is, for example, the device shown in FIG. 4A. Advantageously, the total light available to the system is preserved, and the integrating cavity device 10 assures that the volume inside the cuvette 15 beyond the minimum working height Hₘᵢₙ, is not accessible to interact with the circulating light.

The graph of detector response to changes in sample volume obtained with this setup (FIG. 6, right) that uses the integrating cavity device 10 shows that the sensitivity of measurements to small differences in volumes of the sample has been significantly reduced or removed.

The masking enclosure 27, for example, the reflective exterior of the integrating cavity device 10 prevents the majority of light rays from interacting with the unexposed cuvette section and the unexposed cuvette contents and allows the light to continue to recirculate around the integrating cavity or other optical arrangement. This allows for a consistent detector response for all volumes greater than the minimum working height Hₘᵢₙ. From an experimental design perspective, advantageously, this greatly reduces the amount of sample preparation time, significantly lowers the level of operational expertise required to produce results, and increases confidence in the accuracy of results.

As mentioned above, FIGS. 7A and 7B show solutions, such as a removable ‘sleeve’ shield or a removable cuvette holder with shield walls, which assure easy separation of the two components for individual cleaning and the rapid preparation of new samples. However, if these components were not to be reassembled in the exact same way, there may be errors that arise from measurement-to-measurement.

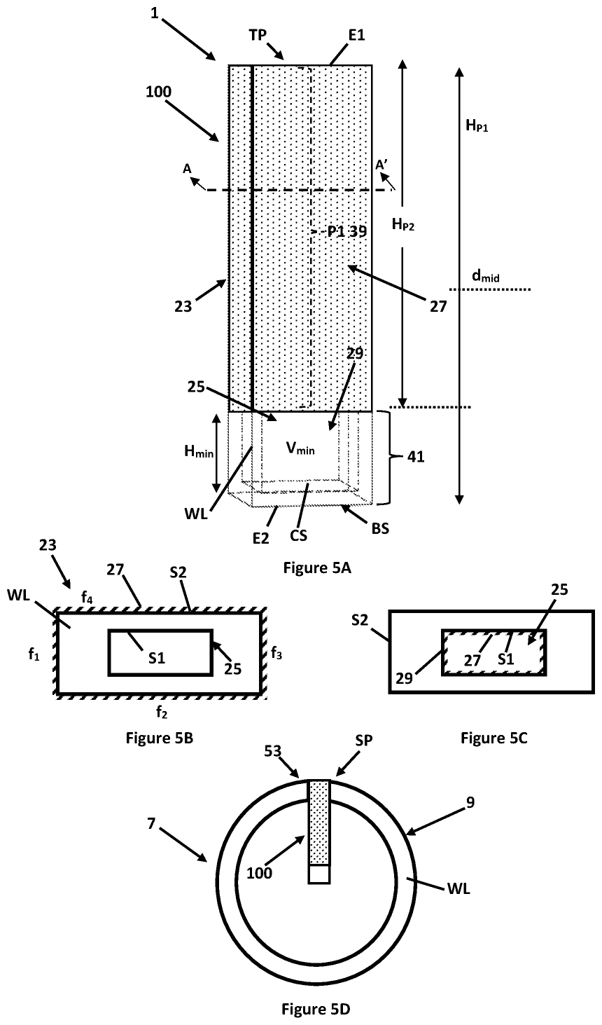

Another embodiment of the present disclosure, for which a non-limiting example is shown in FIGS. 5A to 5D provide a more permanent solution by altering the cuvette 15 internal or external surfaces, for example, with the use of reflective paints or the growth or deposition of a reflective layer on either of these surfaces permitting to alleviate these error concerns.

FIG. 5A shows another exemplary embodiment of the integrating cavity device 1, 100 according to the present disclosure. The integrating cavity device 100 comprises a container 23 defining or comprising an inner receptacle or inner cavity 25 configured to receive and hold a liquid or fluid. The inner receptacle 25 extends through the container 23. The container 23 includes an opening or open top TP (such as that shown in FIG. 1) and a base BS comprising a closure or closed bottom CS to retain a liquid inside when inserted via the opening TP.

The container 23 includes a hollow passage 29, for example, an elongated hollow passage extending through the container 23 and which is closed by the closure CS. The container 23 includes the base BS sealing or closing the elongated hollow passage 29 via the closure CS to define or provide the inner receptacle 25 for receiving and holding the liquid LQ.

The integrating cavity device 100 further includes the masking enclosure (or concealing encasement) 27 configured to optically mask or conceal at least a portion P1 of the inner receptacle 25 from incident or impinging light, for example, reflected from the inner surface 11 of the optical cavity 5.

The masking enclosure 27 encloses or surrounds the inner receptacle 25 to shield the inner receptable 25 from incident or impinging light.

The masking enclosure 27 extends along the container 23 to define a concealed inner receptacle section 39 and to permit (partial of full) panoramic exposure of a second portion 41 of the inner receptacle 25 to optical cavity reflections. Lateral or panoramic exposure is restricted to the second portion 41 of the inner receptacle 25. The masking enclosure 27 extends along the container 23 to delimit the unconcealed inner receptacle section 41 that panoramically exposes a preset or standardized fluidic volume Vₘᵢₙ or a standardized distance/height Hₘᵢₙ of the inner receptacle to optical cavity reflections.

A predetermined or standardized volume Vₘᵢₙ or a predetermined or standardized container section of length/height Hₘᵢₙ restricts light exposure of a liquid in the cuvette 15 to the same predetermined or standardized volume Vₘᵢₙ each time the integrating cavity device 100 is assembled in the integrating cavity device 100.

The container 23 includes at least one wall or body WL, for example, an elongated and surrounding wall WL (FIG. 5A) defining the inner receptacle 25. The at least one wall WL comprises or defines an inner surrounding surface S1 of the container 23 (FIG. 5B). The inner surrounding surface S1 surrounds or encircles a liquid or fluid when located inside the container 23.

The container 23 further includes an outer surrounding surface S2. The at least one wall WL may, for example, define the outer surface S2. The outer surrounding surface S2 surrounds or encircles the inner surrounding surface S1 and the inner receptacle 25.

The masking enclosure 27 may be provided/deposited on or attached to the outer surface S2 of the container 23, as shown in FIG. 5B. The masking enclosure 27 may, for example, be or comprise a deposit or deposit layer (or bound deposit or bound deposit layer) deposited on and/or adhered/stuck to the outer surface S2 of the container 23. Alternatively or additionally, the material of the outer surface S2 of the container 23 may define the masking enclosure 27. The outer surface S2 may, for example, be patterned or have a non-transmitting roughness or a diffusive surface roughness.

The masking enclosure 27 may, for example, comprises or consists of a diffusely or specular reflecting material or layer; or a broadband light absorbing material or layer. Exemplary materials or components are for example the same as those that have been mentioned previously herein.

Alternatively or additionally, the masking enclosure 27 may be provided on or attached to the inner surface S1 of the container 23 (for example, in the same manner previously described in relation to outer surface S2) to optically mask or conceal at least a portion P1 of the inner receptacle 25 from incident or impinging light, as shown in FIG. 5C.

The masking enclosure 27 comprises or consists of a material that shields, masks or conceals one or more portions P1 of the inner receptacle 25 or the content of the inner receptacle 25. A portion of the liquid is thus shielded from incident or impinging light when received in the inner receptacle 25.

The masked portion P1 of the inner receptacle 25 may, for example, be a circumferential or tubular masked portion, as shown cross-sectionally in FIGS. 5B and 5C. The circumferential portion may extend fully or partially circumferentially and extends in an elongated direction of extension of the container 23 or integrating cavity device 10.

The masking enclosure 27 may, for example, extend to cover (substantially) the entire circumferential outer surface S2 of the container 23 that encircles the inner receptacle 25, and extend to provide a partially elongated circumferential shielding. The masking enclosure 27 extends for example, on the outer surface S2, a distance H_{P2} (FIG. 5A) from an upper or first extremity E1 that is less than the total distance H_{P1} between the upper extremity E1 and a lower or second extremity E2, for example between 5% and 35% less than the total distance H_{P1}.

As a result, an elongated circumferential portion of the inner receptable 25 and any liquid therein is circumferential shielded from laterally incident or impinging light, that is, a surround shielding of a first or upper portion of the inner receptable 25 is assured.

The masking enclosure 27 extends along the container 23 to mask, from optical cavity reflections, a first portion 39 of the inner receptacle 25 and a first portion of a liquid sample when received therein, and to panoramically expose, to optical cavity reflections, a second portion 41 of the inner receptacle 25.

A first or upper portion 39 (for example, an elongated circumferential portion) of the inner receptacle 25 and liquid therein is thus shielded from incident or impinging light or optical reflections of the optical cavity 5, while a second or lower portion 41 of the inner receptacle 25 and the liquid therein, that is to be located closer to the center of the integrating cavity 7, is panoramically or fully panoramically exposed to incident or impinging light or optical reflections of the optical cavity 5.

The liquid volume exposed to incident or impinging light or optical reflections of the optical cavity 5 is largely restricted to the standardized or preset liquid volume Vₘᵢₙ located in the second or lower portion of the inner receptacle 25.

Alternatively, or additionally, the masking enclosure 27 may similarly extend to partially or fully cover the inner surface S1 of the container 23 to shield an elongated circumferential portion of the inner receptable 25. The masking enclosure 27 may, for example, be present on both the inner surface S1 and the outer surface S2, fully or partially in a manner assuring shielding of the inner receptacle 25.

The masking enclosure 27 defines the concealed inner receptacle section 39 and permits (partial or full) panoramic exposure of a second or lower portion 41 of the container 23 or the inner receptacle 25 to optical cavity reflections.

The masking enclosure 27 extends along the container 23 permitting to delimit an unconcealed inner receptacle section of height Hₘᵢₙ and permitting to panoramically expose the preset or standardized fluidic volume Vₘᵢₙ to incident light or optical cavity reflections.

The second or lower portion 41 of the container 23 or the inner receptacle 25 is located at or in proximity to the extremity of the container 23 or the inner receptacle 25 comprising the closure CS. The second or lower portion 41 is located, for example, between (i) mid-distance d_{mid} of the total distance H_{P1} between the upper extremity E1 and a lower or second extremity E2, and (ii) the closure CS.

While the example of FIG. 5A shows a fully panoramic exposure to light of the second or lower portion 41 in which light interacts with the content of the lower portion 41 from all surrounding or circumferential directions, other configurations or patterns of the exposure masking enclosure 27 may also be provided.

For example, the exposure masking enclosure 27 may be provided to assure a panoramic exposure to light through directly opposing windows defined by the masking enclosure 27 on each façade of the container 23, for example, façades f₁, f₂, f₃ and f₄ of the rectangular cross-sectional embodiment of FIGS. 5A to 5C. The exposure masking enclosure 27 may (substantially) cover or conceal the inner receptacle 25 and define one or more optically communicating windows to determine the second or lower unconcealed portion.

The masking enclosure 27 may, for example, define a separate circumferential band around the lower or second extremity E2 to conceal the closure CS and an object positioned on the closure CS, for example, a stirring device.

FIG. 5D shows the integrating cavity device 100 placed in and retained by the integrating cavity 7, and is removable from the integrating cavity 7. The hollow body 9 includes a sample port SP comprising a channel defined by and extending fully through the wall WL of the integrating cavity 7.

The integrating cavity 7 includes, for example, positioning means or a positioning mechanism configured to locate or fix the standardized fluidic volume Vₘᵢₙ or a predetermined or standardized section of length/height Hₘᵢₙ of the integrating cavity device 100 centrally in the optical cavity 5 for exposure to optical cavity reflections.

The positioning means or positioning mechanism may comprise, for example, one or more spring clamps located for example on a surface of the channel passage of the wall of the integrating cavity 7 allowing the integrating cavity device 100 to be retained by the sample port and the integrating cavity 7, and subsequent removed from the integrating cavity 7.

Alternatively, a mount or holder device configured to receive/grip the base BS of the integrating cavity device 100 may be included, and the mount may be permanently fixed inside the integrating cavity 7, or alternatively is inserted into the integrating cavity 7 with the integrating cavity device 100 to locate the integrating cavity device 100 inside the integrating cavity 7. The mount can, for example, be inserted into the integrating cavity 7 and be removably seated in a lower section of the integrating cavity 7 while holding the device 100 in a measurement position, or can be seated on a surface external the integrating cavity 7 and extend from that external surface into the integrating cavity 7 to locate the integrating cavity device 100 inside the integrating cavity 7 in a measurement position.

Alternatively, the previously described mount or holder device 51 (FIG. 4E) configured to receive and hold the integrating cavity device 100 can be used and is configured to be received by the receiving surface 53 of the integrating cavity 7 located around the sample port SP. The mount or holder device 51 is configured to hold the integrating cavity device 100 to locate the integrating cavity device 100 in an aligned position and extending into the integrating cavity 7 so that the base BS of the integrating cavity device 100 is located centrally inside the integrating cavity 7 and at a measurement position. The mount or holder device 51 may also be configured to adjust the position of the base BS inside the integrating cavity 7, for example, to raise or lower the location of base BS of the integrating cavity device 100.

The integrating cavity device 100 extends in an elongated manner so as to be located inside the optical cavity 5 of the integrating cavity 7 when received or held by the integrating cavity 7.

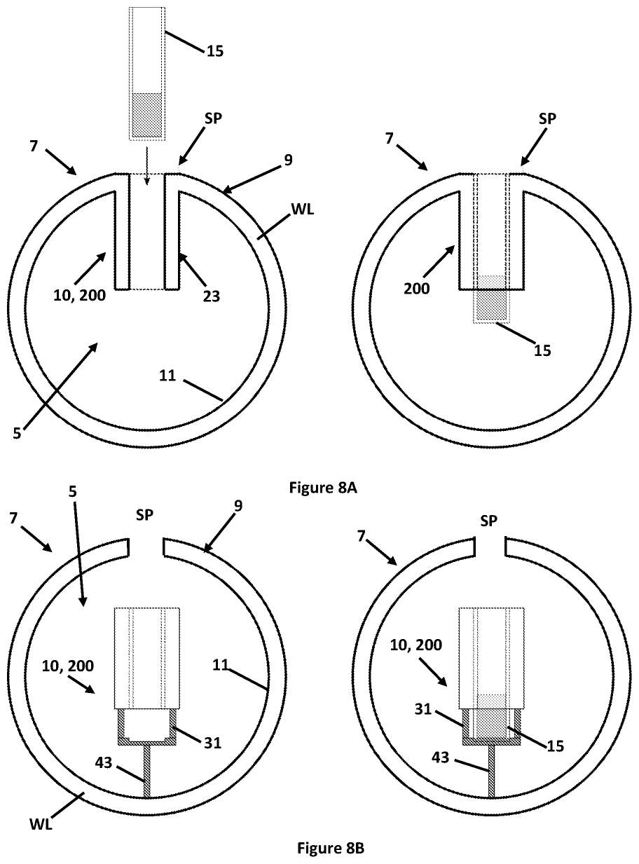

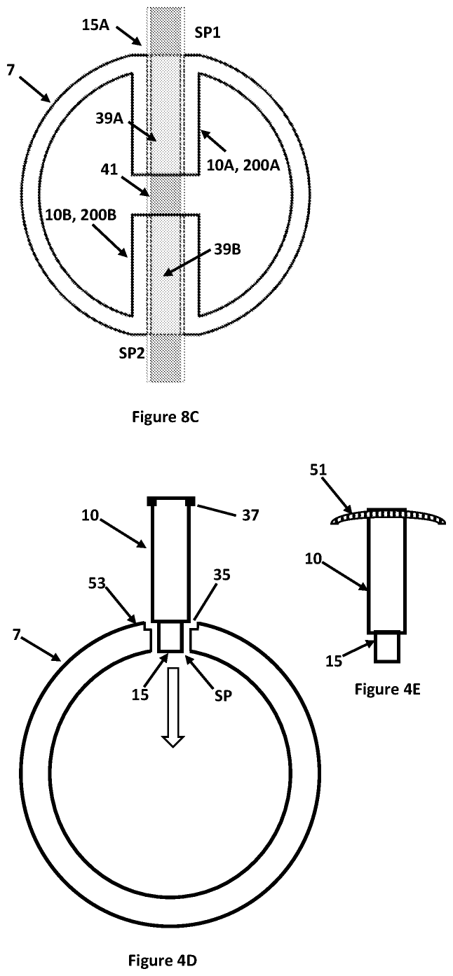

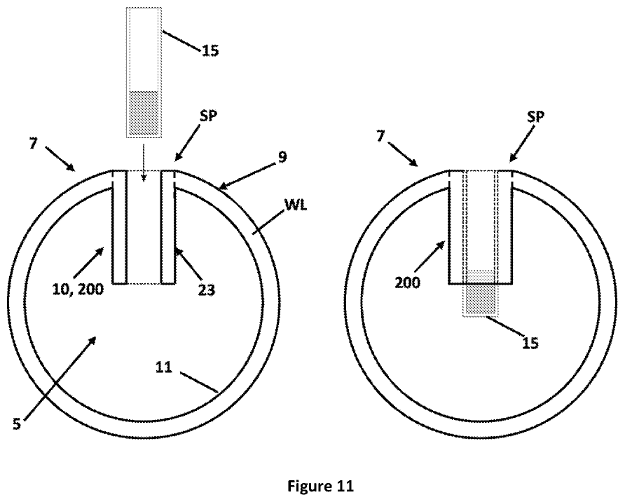

FIGS. 8A and 8B and FIG. 11 show yet other exemplary embodiments of integrating cavity devices of the present disclosure included in an integrating cavity and, for example, concern what can be considered static improvements to the integrating cavity 7 to mitigate the negative effects of volume differences via improvement of the integrating cavity sample port (see for example, FIG. 8A), or including the integrating cavity device inside the integrating cavity 7, for example, via an anchored sample mount 31 attached to an integrating cavity device 10 such as that of FIG. 4A (see for example, FIG. 8B). The cuvette 15 is depicted before insertion (left) and after insertion (right) in FIGS. 8A, 8B and 11.

The sample port SP of the integrating cavity 7 may include, for example, the integrating cavity device 1, 10, 200, the integrating cavity device 1, 10, 200 extending from an opening or channel defined by the sample port SP and extending inside the optical cavity 5 of the integrating cavity 7. The integrating cavity device 1, 10, 200 extends, for example, from the sample port SP towards the center of the optical cavity 5.

The integrating cavity 7 includes, for example, a non-removable integrating cavity device 200, that is, non-removable during normal use of the integrating cavity 7. Alternatively, the integrating cavity 7 includes, for example, a removable integrating cavity device 1, 10, 200, attached or connected to the sample port SP by, for example, a form-fit or a press-fit or an interference fit (see, for example, FIG. 11).

The integrating cavity 7 comprises the hollow body 9 that includes a sample port SP comprising a channel or opening that is defined by and extends fully through the wall WL of the integrating cavity 7 to allow insertion of a sample or cuvette 15.

The integrating cavity device 10, as described above in relation to FIG. 4A, may, for example, be included in the wall WL and/or be integral with the wall WL and/or the hollow body of the integrating cavity 7 to form the integrating cavity device 200 shown, for example, in FIGS. 8A and 8B.

The integrating cavity device 10, 200 can be, for example, of unitary construction with the integrating cavity 7.

The elongated container 23 may, for example, be attached or fixed to the wall WL and/or the hollow body of the integrating cavity 7 at the sample port. The elongated container 23 may, for example, be attached or fixed to the wall WL or hollow body at the first or upper extremity E1 of the container 23 and extends (substantially) towards the center of the optical cavity.

When of unitary construction provided for example by an extruded fabrication or extruded sample port design, the wall WL of the integrating cavity 7 at the sample port SP extends from the wall WL (substantially) towards the center of the optical cavity 5 to define the container 23, and the integrating cavity device 10 with the features as previously described in relation to the embodiment of FIG. 4A is provided in the integrating cavity 7.

Alternatively, the integrating cavity device 10 may be introduced after the optical design of the integrating cavity and introduced as an add-on to existing integrating cavities as an anchored mount. The integrating cavity device 10 may be attached to the hollow body or wall WL of the integrating cavity 7 by a support or anchor 43. For example, a support or anchor 43 may extend between the hollow body or wall WL of the integrating cavity 7 and the mount 31 of the integrating cavity device 10 to locate the integrating cavity device 10 and sample or cuvette 15 centrally inside the optical cavity 5.

Such static improvements to the optical assembly or integrating cavity provide some of the benefits of both strategies.

Integrating cavity devices used in this way are fixed in place and produce consistent optical paths. Thus, the measurement-to-measurement errors would only be due to replacing the cuvettes back in the same spot, which is a fundamental factor for any optical use of a cuvette. The integrating cavity device of this embodiment will be specific for a cuvette geometry; if another size or shape of cuvette were to be of interest, a new integrating cavity or sample mount would have to be produced. Nevertheless, an undersized cuvette can still benefit from an integrating cavity device configured for a larger one, albeit with a possibly higher minimum working height as more of the internal surfaces are exposed.

FIG. 8C shows yet a further exemplary embodiment in which a plurality of integrating cavity devices of the present disclosure are included in an integrating cavity 7. The integrating cavity 7 includes a first integrating cavity device 10A which is identical to that previously described in relation to the embodiment of FIG. 4A and FIG. 8A or 11, and additionally includes a second integrating cavity device 10B which is identical to that previously described in relation to the embodiment of FIG. 4A (for example, similar to that of FIG. 8A or 11 but located at a different position on the integrating cavity 7). The integrating cavity 7 thus includes a second sample/cuvette port SP2 in addition to a first sample/cuvette port SP1.

The first integrating cavity device 10A is located (directly) opposite the first integrating cavity device 10A to allow the cuvette 15A to extend between the first and second ports SP1, SP2 when received in the integrating cavity 7.

The first integrating cavity device 10A is located (directly) opposite the first integrating cavity device 10A so that the cuvette 15A pass and extend through the first integrating cavity device 10A and simultaneously pass and extend through the second integrating cavity device 10B.

A first portions 39A, 39B of the inner receptacle and liquid therein are shielded from incident or impinging light or optical reflections of the optical cavity 5, while the second portion 41 and the liquid therein, that is to be located closer to the center of the integrating cavity 7, is panoramically or fully panoramically exposed to incident or impinging light or optical reflections of the optical cavity 5.

The cuvette 15A may be identical to that described previously and may be fully filled with a liquid to be investigated. A removable closure may be included to close the open end or open top TP to allow the cuvette to be inserted and held (substantially) horizontally into the integrating cavity 7. The above-described integrating cavity devices may include the masking enclosure 27 comprising the diffusely or specular reflecting material extending on the outer surface S2 of the integrating cavity device, and additionally may include an absorbing material extending on the inner surface S1 of the integrating cavity device.

FIG. 10A shows an exemplary integrating cavity device as described previously in the present disclosure, and FIG. 10B shows an example of a further embodiment of the integrating cavity device including an absorbing material extending on the inner surface S1 of the integrating cavity device. FIG. 10A shows an example of how light may interacts with the internal surface of integrating cavity device when masking is assured using only reflecting materials on outer surface S2. A portion of the inner receptacle or inner cavity 25 such as a circumferential or tubular masked portion but light may sometimes enter via other unshielded portions such as an unshielded top portion of the inner receptacle or inner cavity 25 as shown, for example, in FIG. 10A. To address this, the integrating cavity device 1 may additionally include the internal absorbing layer or material provided, attached or deposited on the inner surface S1, as shown, for example, in FIG. 10B.

This provides a double light shield of the first portion of the inner receptacle or cavity 25.

Although a purely-reflecting integrating cavity device prevents most of the light from interacting with the enclosed sample volume, a small proportion of the light from the integrating cavity may be able to enter the cuvette at certain angles and interact with the internal device surfaces. These events could result in at least a couple avenues of overreporting: due to increased ‘visible’ volume at low concentrations and due to more light paths ‘seen’ in the reference that are not seen in the sample at high concentrations. These would likely compound and be difficult to account for, leading to inaccuracies with every measurement.

The degrees of inaccuracies from these kinds of effects would be highly dependent on the particular optical setups and some may even be negligible. However, one way to mitigate this consistently is to alter the internal surface of the integrating cavity device to be strongly absorbing, which would serve to quench any light that makes it into the covered volume or portion. This internal absorption would occur regardless of the absorption strength of the sample or reference material, thus normalizing their resulting detection responses and improving the accuracy of the system across all concentrations of sample. Because the quenched light is comparatively rare anyway, this should not result in too much of a loss of maximum detectable response. The amount of loss and degree of protection this strategy would offer can be adjusted by adjusting the percentage area coverage of absorbing material on the inner surface S1, which can be partially or fully covered by the absorbing material.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments and be given the broadest reasonable interpretation in accordance with the language of the appended claims. The features of any one of the above-described embodiments may be included in any other embodiment described herein.

1. Integrating cavity device for an optical cavity of an integrating cavity, the integrating cavity device comprising:
a container defining or comprising an inner receptacle or cavity configured to receive a liquid or a cuvette;
a masking enclosure configured to mask at least one portion of the inner receptacle or cavity
wherein the integrating cavity device is configured to be received or held by an integrating cavity, and the integrating cavity device extends in an elongated manner so as to be located inside the optical cavity of the integrating cavity when received or held therein; and
wherein the masking enclosure extends along the container to mask, from optical cavity reflections, a first portion of the inner receptacle or cavity and a first portion of a liquid sample when received therein, or a first portion of a cuvette, when received therein; and panoramically expose, to optical cavity reflections, a second portion of the inner receptacle or cavity or a second portion of the cuvette, when received in the inner receptacle or cavity.

2. Integrating cavity device, according to claim 1, wherein the masking enclosure extends along the container to define at least one concealed inner receptacle section and to permit panoramic exposure of the second portion of the inner receptacle or cavity to optical cavity reflections, or permit panoramic exposure of the second portion of the cuvette to optical cavity reflections when received in the integrating cavity device.

3. Integrating cavity device according to claim 1, wherein the masking enclosure extends along the container to delimit at least one unconcealed inner receptacle section that panoramically exposes a standardized fluidic volume to optical cavity reflections, or to permit to delimit at least one unconcealed inner receptacle section of the cuvette to panoramically expose a standardized fluidic volume to optical cavity reflections.

4. Integrating cavity device according to claim 1, wherein the container includes at least one elongated hollow passage extending fully through the container.

5. Integrating cavity device according to claim 1, further including positioning means configured to locate a standardized fluidic volume of the cuvette, outside the container for exposure to optical cavity reflections of the integrating cavity.

6. Integrating cavity device according to claim 5, wherein the positioning means comprises a wedging or blocking mechanism configured to wedge or block the cuvette against the integrating cavity device, or at least one detent mechanism, or at least one set screw, or at least one mount extending from the container and defining a landing configured to position a base of the cuvette at a standardized distance from the container.

7. Integrating cavity device according to claim 1, wherein the container includes at least one elongated hollow passage extending through the container and a base sealing the elongated hollow passage to define the inner receptacle for receiving and holding the liquid.

8. Integrating cavity device according to claim 7, wherein the container includes at least one unconcealed inner receptacle section defining a standardized fluidic volume for panoramic exposure to optical cavity reflections.

9. Integrating cavity device according to claim 1, wherein the container includes at least one outer surface and at least one inner surface, and the masking enclosure extends on the at least one outer surface or on the at least one inner surface

10. Integrating cavity device according to claim 9, wherein the masking enclosure comprises a deposit deposited and adhered to the at least one outer surface or to the at least one inner surface of the container.

11. Integrating cavity device according to claim 1, wherein the masking enclosure comprises a diffusely or specular reflecting material, or a broadband light absorbing material.

12. Integrating cavity device according to claim 1, wherein the masking enclosure comprises a diffusely or specular reflecting material extending on the at least one outer surface, and an absorbing material extending on the at least one inner wall to provide a double light shield of the at least one portion of the inner receptacle or cavity

13. Integrating cavity device according to claim 1, further including an upper integrating cavity engagement connection or connector configured to connect or attach the integrating cavity device to a sample port of the integrating cavity to allow an upward and downward displacement of the liquid and the cuvette inside the integrating cavity when the liquid and the cuvette are inserted into the integrating cavity.

14. Integrating cavity device, according to claim 13, wherein the upper integrating cavity engagement connection or connector is configured to connect or attach the integrating cavity device to the integrating cavity at a summit of the integrating cavity to hold the integrating cavity device suspended and extending inside the integrating cavity from the connection of the integrating cavity device at the summit of the integrating cavity.

15. Integrating cavity including the integrating cavity device according to claim 1.

16. Integrating cavity according to claim 15, wherein at least one port of the integrating cavity includes the integrating cavity device that extends from an opening or channel defined by the port and extends inside the optical cavity of the integrating cavity; or wherein the integrating cavity device is of unitary construction with the integrating cavity and extends inside the optical cavity of the integrating cavity.

17. Integrating cavity according to claim 16, wherein a first port of the integrating cavity includes a first integrating cavity device and a second port of the integrating cavity includes a second integrating cavity device the first and second ports being located opposite each other to allow a cuvette to extend between the first and second ports.

18. Spectroscopic measurement method including the steps of:
providing the integrating cavity device of claim 1; and
using the provided integrating cavity device to obtain spectroscopic measurements.

19. A spectroscopic measurement method, the method comprising:
providing the integrating cavity of claim 15; and
using the provided integrating cavity to obtain spectroscopic measurements.
